(19) United States
(12) Patent Application Publication
(10) Pub. No.: US 2022/0284717 A1
(43) Pub. Date: Sep. 8, 2022

(54) CONSCIOUSNESS DETERMINATION DEVICE AND CONSCIOUSNESS DETERMINATION METHOD

(71) Applicant: DENSO CORPORATION, Kariya-city (JP)

(72) Inventors: Keisuke KUROKAWA, Kariya-city (JP); Kaname OGAWA, Kariya-city (JP)

(21) Appl. No.: 17/826,354

(22) Filed: May 27, 2022

Related U.S. Application Data
(63) Continuation of application No. PCT/JP2020/044509, filed on Nov. 30, 2020.

(30) Foreign Application Priority Data
Dec. 2, 2019 (JP) 2019-218106

(51) Int. Cl. G06V 20/59; G06T 7/70; G06V 20/56

(52) U.S. Cl. CPC G06V 20/597; G06T 7/70; G06V 20/588; G06T 2207/30201; G06T 2207/30268; B60K 35/00

(57) ABSTRACT

In a consciousness determination device, a time series of a plurality of detection elements that includes a line-of-sight state indicating to which of a plurality of preset viewable areas a line of sight of a driver driving a vehicle is directed and an open/closed state of driver's eyes is generated. Detection data is extracted from the time series of the detection elements using a time window having a preset time width. The line-of-sight state of the driver with respect to each of the plurality of viewable areas is aggregated using the detection data. Based on an aggregation result, at least one of (i) a state of consciousness of the driver with respect to each of the plurality of viewable areas and (ii) a state of consciousness of the driver with respect to an event associated with each of the plurality of viewable areas is determined.

### CROSS REFERENCE TO RELATED APPLICATIONS

The present application is a continuation application of International Patent Application No. PCT/JP2020/044509 filed on Nov. 30, 2020, which designated the U.S. and claims the benefit of priority from Japanese Patent Application No. 2019-218106 filed on Dec. 2, 2019. The entire disclosures of all of the above applications are incorporated herein by reference.

### TECHNICAL FIELD

The present disclosure relates to a technique for detecting a driver's state of consciousness from an image of the driver.

### BACKGROUND

For example, there is a technology of suppressing distraction and an excessive work load of a driver, which will cause a traffic accident, by detecting the direction of driver's eyes and the direction of a driver's head. Specifically, the driver's distraction or looking aside is detected by using a percentage of road center (hereinafter, referred to as PRC). The PRC is a ratio of a gaze at the road front, which is a direction that driver's eyes are typically oriented during driving, and is calculated from a sum of a time for which a driver looks at the road front and a time for which the driver glances at other directions than the road front.

### SUMMARY

The present disclosure describes a consciousness determination device and a consciousness determination method, which determine a driver's consciousness state in any directions. According to an aspect of the present disclosure, a time series of a plurality of detection elements that includes a line-of-sight state indicating to which of a plurality of preset viewable areas a line of sight of a driver driving a vehicle is directed and an open/closed state of driver's eyes may be generated. Detection data may be extracted from the time series of the detection elements using a time window having a preset time width. The line-of-sight state of the driver may be aggregated with respect to each of the plurality of viewable areas using the detection data. Based on an aggregation result, at least one of (i) a state of consciousness of the driver with respect to each of the plurality of viewable areas and (ii) a state of consciousness of the driver with respect to an event associated with each of the plurality of viewable areas may be determined.

### BRIEF DESCRIPTION OF DRAWINGS

Features and advantages of the present disclosure will become more apparent from the following detailed description made with reference to the accompanying drawings, in which:

FIG. 1 is a block diagram showing a configuration of a consciousness determination device according to an embodiment;

FIG. 2 is a flowchart of a state determination processing;

FIG. 3 is an explanatory diagram showing an acquired image and results of face detection and face feature point detection;

FIG. 4 is an explanatory diagram showing viewable areas;

FIG. 5 is an explanatory diagram showing an example of a raw data of gazing areas and time windows used for extracting detection data;

FIG. 6 is a diagram showing an aggregation result represented in a histogram format;

FIG. 7 is an aggregation result represented in a graph format;

FIG. 8 is a flowchart of a consciousness map display processing;

FIG. 9 is an explanatory diagram showing a consciousness map;

FIG. 10 is an explanatory diagram showing a relationship between determination results of consciousness states and a display on the consciousness map;

FIG. 11 is a flowchart of a control restriction processing; and

FIG. 12 is a flowchart of a control restriction processing according to another embodiment.

### DETAILED DESCRIPTION

To begin with, a relevant technology will be described only for understanding the embodiments of the present disclosure.

In a relevant technology that detects the driver's distraction or looking aside by using the PRC, the present inventors have found the following issues as a result of their detailed study.

That is, the relevant technology evaluates only for the road front as an evaluation target, and thus only the driver's distraction and looking aside can be detected. As such, it was difficult to deal with an event that occurs in areas other than the road front. Further, in the relevant technology, the evaluation is not made for the area that the driver intentionally views. Therefore, an alarm is issued even if the driver intentionally views the area other than the road front, which causes annoyance to the driver.

According to an aspect of the present disclosure, it is provided a technology of determining a driver's state of consciousness in any direction.

According to an aspect of the present disclosure, a consciousness determination device includes an information generation unit, an extraction unit, an aggregation unit, and a determination unit.

The information generation unit generates a time series of detection elements including a line-of-sight state indicating to which of a plurality of preset viewable areas a line of sight of a driver driving a vehicle is directed and an open/closed state of driver's eyes. The extraction unit extracts detection data from the time series of the detection elements using a time window having a preset time width. The aggregation unit aggregates the line-of-sight state of the driver with respect to each of the plurality of preset viewable areas using the detection data. The determination unit determines at least one of (i) a driver's consciousness state with respect to each of the plurality of preset viewable areas and (ii) a driver's consciousness state for an event associated with each of the plurality of preset viewable areas, from an aggregation result provided by the aggregation unit.

According to an aspect of the present disclosure, a consciousness determination method includes: generating a time series of detection elements including a line-of-sight state indicating to which of a plurality of preset viewable areas a line of sight of a driver driving a vehicle is directed and an open/closed state of driver's eyes; extracting detection data from the time series of the detection elements using a time window having a preset time width; aggregating the line-of-sight state of the driver with respect to each of the plurality of preset viewable areas using the detection data; and determining at least one of (i) a driver's consciousness state with respect to each of the plurality of preset viewable areas and (ii) a driver's consciousness state for an event associated with each of the plurality of preset viewable areas, from aggregation results of the respective viewable areas.

According to the consciousness determination device and the consciousness determination method described above, a driver's consciousness state is determined with respect to each of the viewable areas. That is, it is determined whether or not the line of sight of the driver directed to each of the viewable area is intentional. Therefore, unlike the relevant technology, it is possible to recognize the driver's consciousness state not only in the road front but also in any areas, and thus it is possible to accurately deal with an event occurring in any viewable areas. For example, it is possible to suppress unnecessary alert control or the like due to misrecognition of a driver's looking aside, although the driver is intentionally viewing an area other than the road front. For example, in a case where an event to which the driver needs to pay attention occurs in an area, if the event occurs in the viewable area to which the driver is in conscious, an alert is restricted. If the event occurs in the viewable area to which the driver is not in conscious, the alert may be increased or emphasized. As a result, it is possible to suppress the driver from being bothered by an unnecessary alert.

Hereinafter, embodiments of the present disclosure will be described with reference to the drawings.

### 1. Configuration

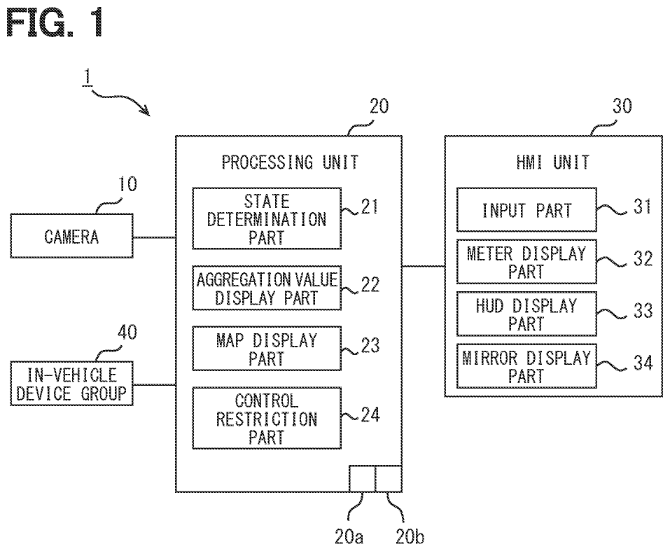

A consciousness determination device 1 shown in FIG. 1 is mounted on a vehicle and determines a driver's consciousness state from a driver's face direction, a driver's line of sight direction, and the like. The consciousness state indicates whether or not the driver's visual recognition is intentional and the driver is aware of an event that occurs in an area in the line of sight direction.

The consciousness determination device 1 includes a camera 10 and a processing unit 20. The consciousness determination device 1 may include a human machine interface (HMI) unit 30 and an in-vehicle device group 40 including in-vehicle devices. The processing unit 20, the camera 10, the HMI unit 30, and the in-vehicle device group 40 may be directly connected to one another or may be connected via an in-vehicle network such as CAN. The CAN is a registered trademark and is an abbreviation of Controller Area Network.

As the camera 10, for example, a known CCD image sensor, CMOS image sensor, or the like can be used. The camera 10 is arranged, for example, such that the face of a driver seated on a driver's seat of the vehicle is included in an imaging range. The camera 10 periodically captures images, and outputs data of the captured images to the processing unit 20.

The processing unit 20 includes a microcomputer having a CPU 20a and a semiconductor memory (hereinafter, simply referred to as the memory 20b) such as RAM or ROM. The processing unit 20 includes a state determination part 21, an aggregation value display part 22, a map display part 23, and a control restriction part 24 as blocks representing functions realized by the CPU 20a as executing a program. The details of processing executed by the respective parts will be described later.

The HMI unit 30 includes an input part 31, a meter display part 32, a HUD display part 33, and a mirror display part 34. The HMI is an abbreviation of human-machine interface.

The input part 31 includes a switch, a keyboard, a touch panel, and the like for receiving instructions from a driver. For example, the input part 31 is configured to be able to receive a display mode switching instruction when displaying the processing result in the processing unit 20.

The meter display part 32 is a device for displaying a speedometer or the like. The HUD display part 33 is a device that visually produces various information by projecting an image onto a windshield or a combiner. The HUD is an abbreviation of head-up display. A display screen of at least one of the meter display part 32 and the HUD display part 33 has an area for displaying contents generated by the aggregation value display part 22 and/or the map display part 23.

The mirror display part 34 is a device for displaying an alert by a function of a blind spot monitor (hereinafter referred to as BSM) on each of two side mirrors of the vehicle.

The in-vehicle device group 40 includes devices, such as various sensors and electronic control units, mounted on the vehicle. The in-vehicle device group 40 at least includes a device that recognizes a white line drawn on a road based on an image taken from a camera that captures the surroundings of the vehicle, and outputs white line information indicating the position and type of the white line, as the recognition result, to the processing unit 20.

### 2. Processing

[2-1, State Determination Processing]

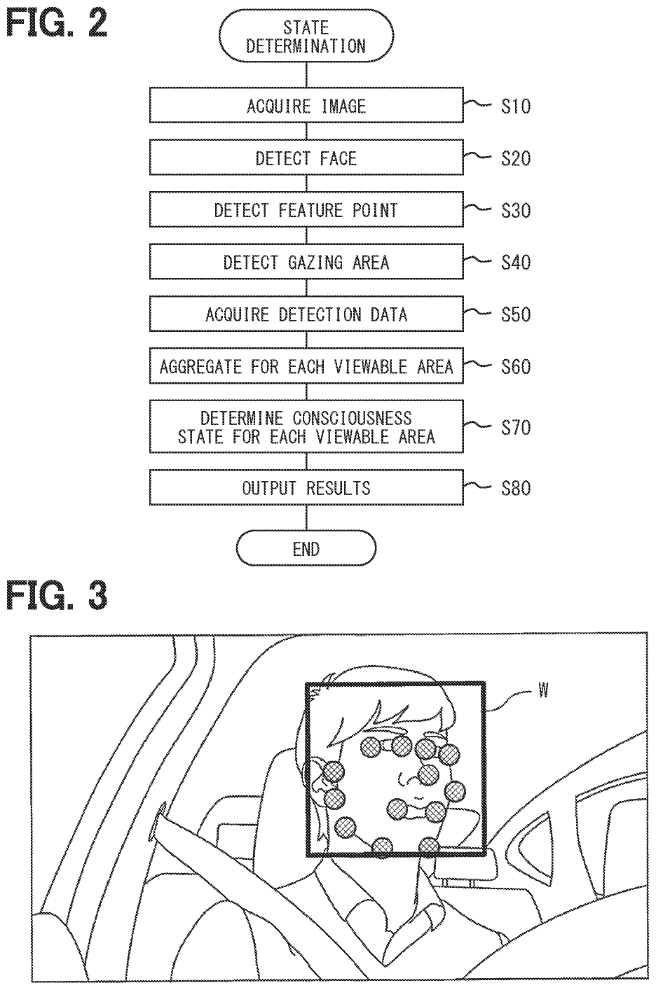

A state determination processing will be described with reference to a flowchart shown in FIG. 2. The state determination processing is executed by the processing unit 20 in order to realize the function of the state determination part 21. The state determination processing is repeatedly started in a preset cycle (for example, 1/20 seconds to 1/30 seconds).

In S10, the processing unit 20 acquires an image equivalent to one frame from the camera 10.

In the following S20, the processing unit 20 executes face detection processing. The face detection processing includes a process of detecting a face area, which is an area where an image of a face is picked up, from the image acquired in S10. In the face detection processing, for example, pattern matching can be used. However, the face detection processing is not limited to the pattern matching. As a result of the face detection processing, for example, an area indicated by a frame W in FIG. 3 is detected as a face area. In a case where feature points can be directly detected from the captured image in a feature point detection processing, which will be described alter, the face detection processing may be omitted.

In the following S30, the processing unit 20 executes the feature point detection processing. In the feature point detection processing, a plurality of facial feature points, which are necessary for specifying the orientation of the captured face and the state of the eyes, are detected by using the image of the face area extracted in S20. For the facial feature points, characteristic parts in contours of such as eyes, nose, mouth, ears, and face are used. As a result of the feature point detection processing, for example, a plurality of facial feature points indicated by shaded circles in FIG. 3 are detected.

In the following S40, the processing unit 20 executes a gazing area detection processing. In the gazing area detection processing, the processing unit 20 detects a direction in which the driver gazes by using images on the periphery of the eyes detected from the image of the face area, based on the plurality of facial feature points detected at S30, and accumulates the detection results in the memory 20b as state information. The state information detected and accumulated may include not only information indicating the gazing direction of the driver but also information indicating an open/closed state of the driver's eyes (for example, a closed eye state).

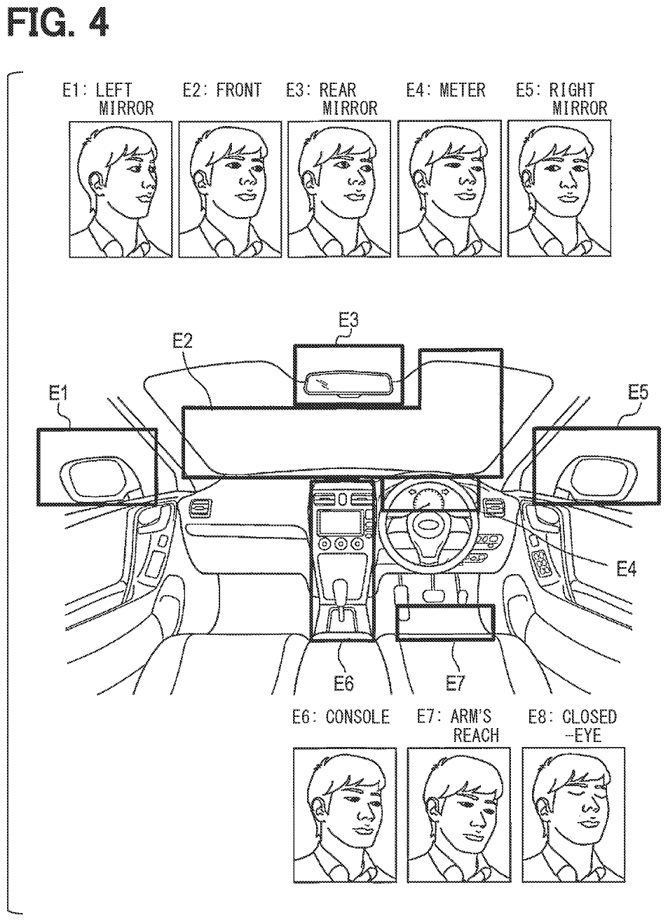

The driver's gazing direction is represented by dividing a range viewable by a driver during driving into a plurality of areas (hereinafter, referred to as viewable areas) and identifying at which viewable area the driver is gazing. As shown in FIG. 4, the viewable areas may include a left side mirror area (hereinafter, referred to as left mirror area) E1, a front area E2, an interior rearview mirror area (hereinafter, referred to as rear mirror area E3), a meter area E4, a right side mirror area (hereinafter, referred to as right mirror area E5), a console area E6, and an arm's reach area E7. However, the method of dividing the viewable areas is not limited to the above areas E1 to E7. As another example, viewable areas that are divided into further smaller areas may be used. As further another example, viewable areas that are divided according to a viewable angle or the like of the driver may be used.

The driver's closed eye state represents a state in which the driver's eyes are closed and the driver is thus not looking at any viewable areas. This state is referred to as a closed-eye E8.

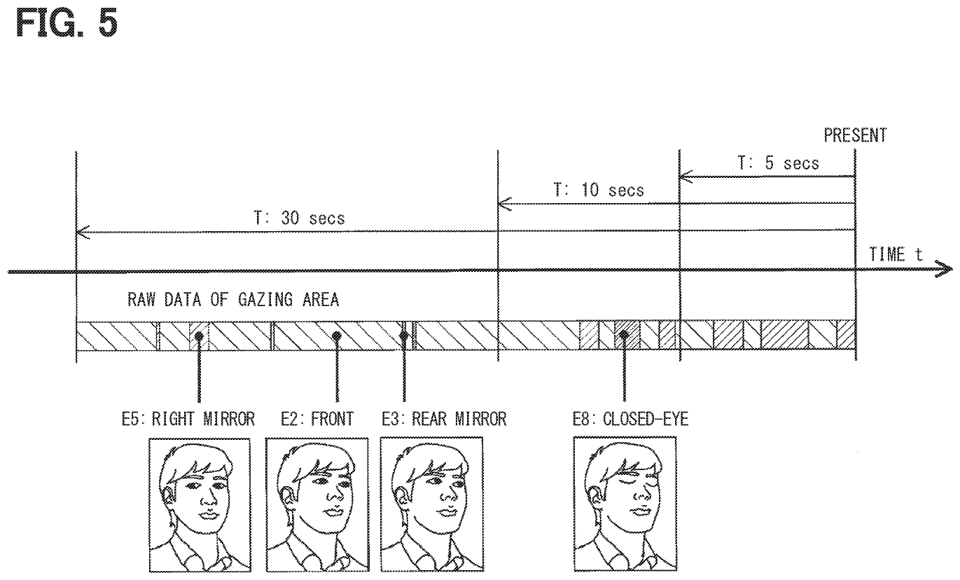

As shown in FIG. 5, state information of the viewable areas E1 to E7 is binarily expressed. When it is determined that the driver is gazing at a relevant viewable area, the state information of the relevant view area indicates 1. When it is determined that the driver is not gazing at the relevant viewable area, the state information of the relevant viewable area indicates 0. The state information of the closed-eye E8 is also binarily expressed. When it is determined that the driver's eyes are in the closed state, the state information of the closed-eye E8 indicates 1. When it is determined that the driver's eyes are not in the closed state, the state information of the closed-eye E8 indicates 0.

At any time point, the state information of any one of the viewable areas E1 to E7 and the closed-eye E8 indicates 1, and the state information of the rest of the viewable areas E1 to E7 and the closed eye E8 indicate 0.

In the processing of S30 and S40, for example, a method for detecting a feature point and detecting a gazing direction using a regression function as proposed in JP2020-126573 A, which is incorporated herein by reference, or the like can be used.

In the following S50, the processing unit 20 extracts detection data from time series data representing the values of the status information of the viewable areas E1 to E7 and the closed-eye E8 accumulated in the memory 20b, using a time window. As shown in FIG. 5, the time window is set to have a predetermined time width T in the past relative to the current time point. FIG. 5 shows examples in which the time width T is 5 seconds, 10 seconds, and 30 seconds, respectively. The raw data of the gazing area shown in FIG. 5 is generated by arranging any of the viewable areas E1 to E7 indicating the value of 1 (i.e., gazing) and the closed-eye E8 indicating the value of 1 along the time axis. The time width T may be switched according to an application that uses the processing result of the state determination processing, or a plurality of types of time width T may be used at the same time.

In the following S60, the processing unit 20 aggregates or totals the frequency (i.e., the number of image frames) with which the value is 1 for each of the viewable areas E1 to E7 and the closed-eye E8 using the extracted detection data. As the aggregation value, a value normalized by dividing the counted number of frames by the time width T of the time window used for extracting the detection data may be used. However, the aggregation value is not limited to the normalized value, and the counted number of frames may be directly used.

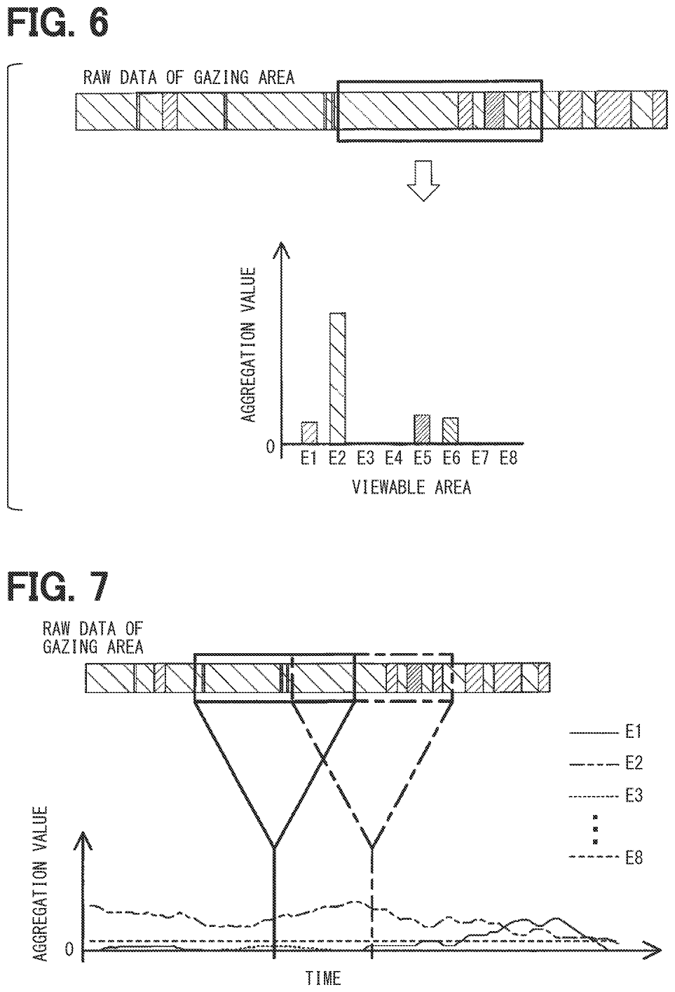

The aggregation result can be represented in the form of a histogram, for example, as shown in FIG. 6. Further, each time the image frame is acquired, an aggregation result based on detection data in which the range of the time window is shifted by one frame can be obtained. FIG. 7 is a diagram showing how the aggregation result changes with the elapse of time in the form of a graph.

In the following S70, the processing unit 20 determines the state of consciousness for each viewable area Ei, in which i=1, 2, . . . 7. For the determination of the state of consciousness, for example, two threshold values TH1 and TH2 are used. Note that the threshold value TH1 is smaller than the threshold value TH2 (TH1<TH2). The threshold value TH1 is used to determine whether or not the driver's consciousness is directed toward the viewable area Ei, that is, whether or not the driver is conscious in the viewable area Ei. The threshold value TH2 is used to determine the degree of driver's consciousness. When the aggregation value of the viewable area Ei is less than the threshold value TH1, it is determined that the driver is “unconscious”. In particular, when the range of the aggregation value for the front area E2 is less than the threshold value TH1, it can be determined that the driver is “looking aside”. When the aggregation value of the viewable area Ei is the threshold value TH1 or more and less than the threshold value TH2, it is determined that the driver is “conscious”. When the aggregation value of the viewable area Ei is the threshold value TH2 or more, it is determined that the driver is “sufficiently conscious”.

The “unconscious” indicates a state in which the driver is not conscious in the viewable area Ei so that the driver cannot recognize a change in an event occurring in the viewable area Ei. The “conscious” indicates a state in which the driver is conscious to the extent that the driver can recognize a change in an event occurring in the viewable area Ei. The “sufficiently conscious” indicates a state in which the driver is intentionally checking the viewable area Ei. The “look aside” indicates a state in which the driver is “unconscious” with respect to the front area of the driver. The threshold values TH1 and TH2 may be different for each of the viewable areas E1 to E7, or may be common to all the viewable areas E1 to E7. The number of threshold values used for determining the state of consciousness is not limited to two, and can be set to any number.

In the following S80, the processing unit 20 stores the determination result in S70 in the memory 20b, and then ends the state determination processing.

[2-2. Aggregation Value Display Processing]

The aggregation value display processing will be described with reference to FIGS. 6 and 7. The aggregation value display processing is executed by the processing unit 20 in order to realize the function of the aggregation value display part 22. In the aggregation value display processing, when an instruction to display the aggregation value and an instruction to specify a display form are input via the input part 31, the aggregation value is displayed in the meter display part 32 or the HUD display unit 33 in the specified display form.

The display form includes a histogram format shown in FIG. 6 and a graph format shown in FIG. 7.

[2-3. Consciousness Map Display Processing]

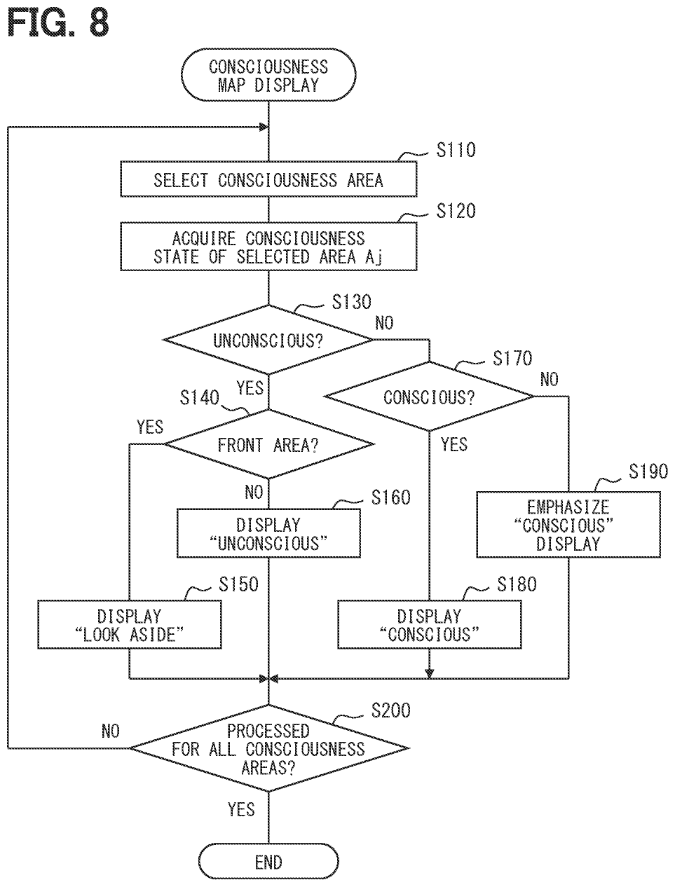

A consciousness map display processing will be described with reference to a flowchart shown in FIG. 8. The consciousness map display processing is executed by the processing unit 20 in order to realize the function of the map display part 23. The consciousness map display processing is started every time a detection result is output from the consciousness determination processing.

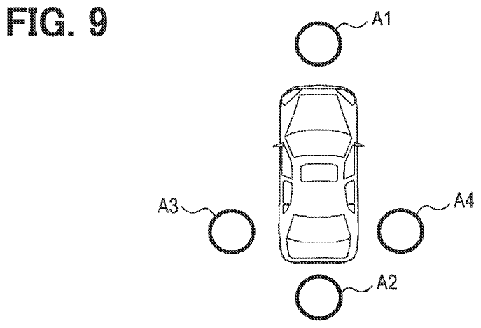

The consciousness map display processing is a processing of displaying the consciousness map on the meter display part 32 or the HUD display unit 33. The consciousness map is a map that shows the peripheral area of a subject vehicle (own vehicle), of which the driver is aware. As shown in FIG. 9, the consciousness map indicates how much the drive's consciousness is directed to each of the areas including a front area A1 of the vehicle, a rear area A2 of the vehicle, a diagonally left rear area A3 of the vehicle, a diagonally right rear area A4 of the vehicle, with reference to the top view of the vehicle. Hereinafter, the areas A1 to A4 are collectively referred to as consciousness areas. The consciousness areas A1 to A4 are each associated with any of the viewable areas E1 to E7, respectively. Specifically, the front area A1 is associated with the front area E2, the rear area A2 is associated with the rear mirror area E3, the diagonally left rear area A3 is associated with the left mirror area E1, and the diagonally right rear area A4 is associated with the right mirror area E5.

In S110, the processing unit 20 selects any of the consciousness areas A1 to A4. The selected consciousness area is referred to as a selected area Aj.

In the following S120, the processing unit 20 acquires the consciousness state of the viewable area Ei associated with the selected area Aj from the memory 20b.

In the following S130, the processing unit 20 determines whether or not the consciousness state acquired in S120 is “unconscious”. When it is determined that the consciousness state is the “unconscious”, the processing is shifted to S140. When it is determined that the consciousness state is not the “unconscious”, the processing is shifted to S170.

In S140, the processing unit 20 determines whether or not the selected area Aj is the front area A1. When it is determined that the selected area Aj is the front area A1, the processing is shifted to S150. When it is determined that the selected area Aj is not the front area A1, the processing is shifted to S160.

In S150, the processing unit 20 sets the front area A1 on the consciousness map displayed on the meter display part 32 or the HUD display unit 33 to a display of “look aside”, and advances the processing to S200.

In S160, the processing unit 20 sets the selected area Aj on the consciousness map displayed on the meter display part 32 or the HUD display unit 33 to a display of “unconscious”, and advances the processing to S200.

In S170, the processing unit 20 determines whether or not the state of consciousness acquired in S120 is “conscious”. When it is determined that the state of consciousness is “conscious”, the processing is shifted to S180. When it is determined that the state of consciousness is not “conscious”, the processing is shifted to S190.

In S180, the processing unit 20 sets the selected area Aj on the consciousness map displayed on the meter display part 32 or the HUD display unit 33 to the display of “conscious”, and advances the processing to S200.

In S190, the processing unit 20 sets the selected area Aj on the consciousness map displayed on the meter display part 32 or the HUD display unit 33 to an emphasized display that emphasizes the display of “conscious”, and advances the processing to S200.

In S200, the processing unit 20 determines whether or not the processing of S120 to S190 has been executed for all of the consciousness areas A1 to A4. When the processing unit 20 determines that the processing of S120 to S190 has not been executed for all of the consciousness areas A1 to A4, the processing returns to S110. When the processing unit 20 determines that the processing of S120 to S190 has been executed for all of the consciousness areas A1 to A4, the processing unit 20 ends the consciousness map display processing.

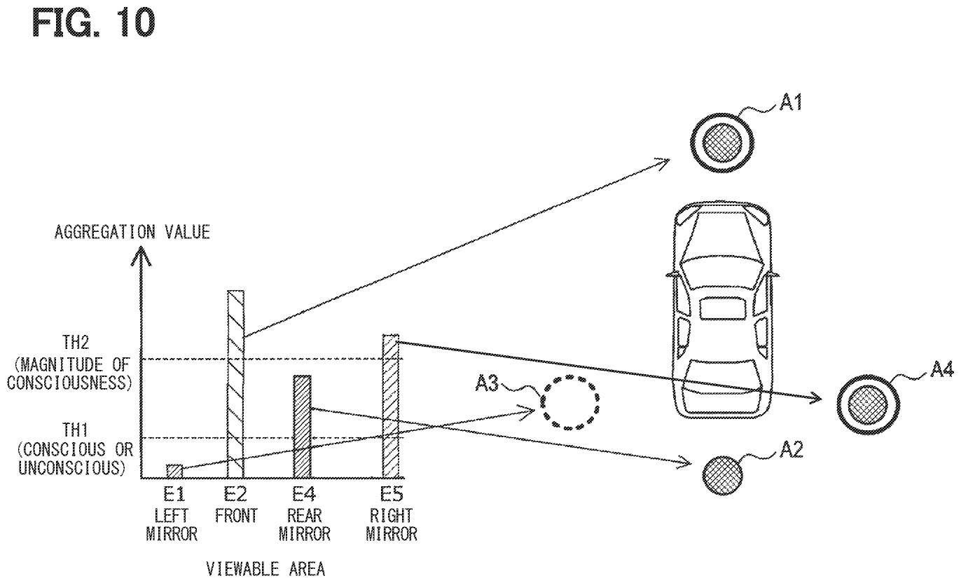

As shown in FIG. 10, for example, a meshed-circle is used for the display of “conscious”, and a meshed-circle with a solid circle surrounding the meshed-circle is used for the emphasized display of “conscious”. Further, although not illustrated in FIG. 10, a blinking “x” mark is displayed for the display of “look aside”. Moreover, a dotted-line circle is used for the display of “unconscious”. Alternatively, nothing may be displayed for the display of “unconscious”. That is, in the consciousness map, the consciousness state of the driver is represented by four levels of “unconscious”, “conscious”, “sufficiently conscious”, and “look aside”, which have different display modes depending on the levels. However, the “look aside” is applied only to the consciousness area A1, and the “unconscious” is applied the consciousness areas A2 to A4 excluding the consciousness area A1.

[2-4. Control Restriction Processing]

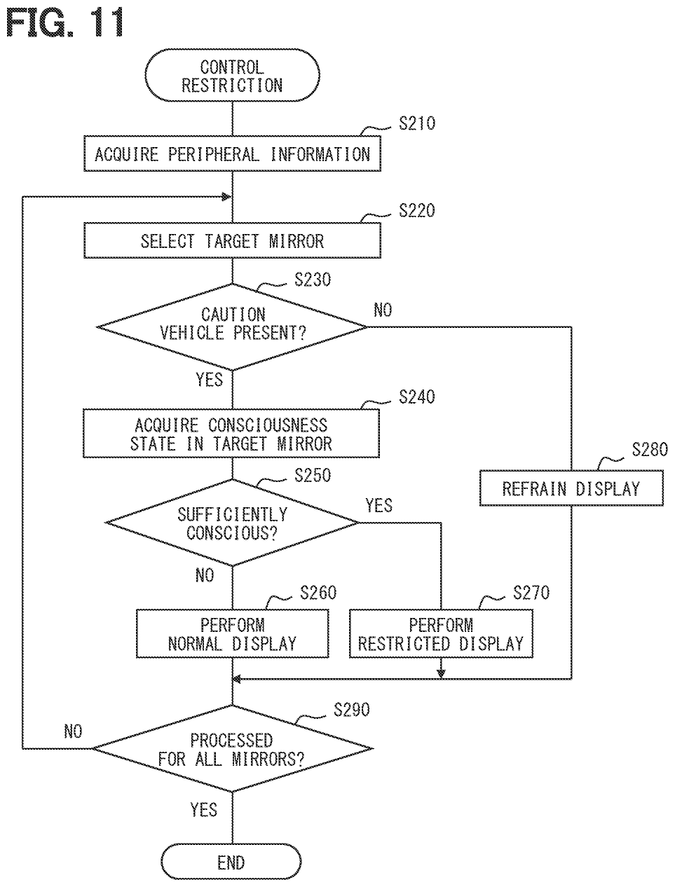

A control restriction processing will be described with reference to a flowchart shown in FIG. 11. The control restriction processing is executed by the processing unit 20 in order to realize the function of the control restriction part 24. The control restriction processing is started every time the detection result is output from the consciousness determination processing.

The control restriction processing is a process of restricting a display by the blind spot monitor (hereinafter referred to as BSM) realized by the mirror display part 34 according to the state of consciousness of the driver. The BSM is a function of detecting a vehicle traveling in an adjacent lane, and turning on or blinking an indicator mounted on the side mirror, when a caution vehicle to which the subject vehicle needs to pay attention, such as a vehicle in a blind spot area on a rear side region, which is difficult to see with the side mirror, or a vehicle approaching rapidly from behind, is detected. That is, the BSM corresponds to an alert control.

In S210, the processing unit 20 acquires peripheral information from the in-vehicle device group 40. The peripheral information includes at least information on other vehicles traveling around the subject vehicle.

In the following S220, the processing unit 20 selects either the right mirror or the left mirror as a target mirror. The target mirror corresponds to a target viewable area.

In the following S230, the processing unit 20 determines whether or not the caution vehicle exists based on the peripheral information acquired in S210. When it is determined that the caution vehicle exists, the processing unit 20 shifts the processing to S240. When it is determined that the caution vehicle does not exist, the processing unit 20 shifts the processing to S280.

In S240, the processing unit 20 acquires the state of consciousness of the driver with respect to the target mirror from the memory 20b.

In the following S250, the processing unit 20 determines whether or not the acquired driver's consciousness state is “sufficiently conscious”. When the acquired driver's consciousness state is not “sufficiently conscious”, the processing unit 20 shifts the processing to S260. When the acquired driver's consciousness is “sufficiently conscious”, the processing unit 20 shifts the processing to S270.

In S260, the processing unit 20 performs a normal display in which the display of the indicator by the BSM is performed as usual, and advances the processing to S290.

In S270, the processing unit 20 performs a restricted display in which the display of the indicator by the BSM is restricted from the normal display, and advances the processing to S290. In the restricted display, the display mode of the indicator is changed from the normal display mode. For example, the blinking display of the indicator may be changed to a simply lighting display. In addition or alternatively, the display size, display color, and/or display position may be changed. Further, the restricted display may include hiding the display of the indicator, that is, the indicator may not be displayed.

In S280, the processing unit 20 refrain the display of the indicator by the BSM and advances the processing to S290.

In S290, the processing unit 20 determines whether or not the processing of S230 to S270 has been executed for all of the right mirror and the left mirror. When it is determined that the processing of S230 to S270 has not been executed for all of the right mirror and the left mirror, the processing unit 20 returns the processing to S220. When it is determined that the processing of S230 to S270 has been executed for all of the right mirror and the left mirror, the processing unit 20 ends the control restriction processing.

### 3. Effects

According to the embodiment described hereinabove, the following effects will be achieved.

(3a) In the present embodiment, the driver's consciousness state is determined for the plurality of viewable areas E1 to E7. Namely, the driver's consciousness state can be determined for each of the viewable areas E1 to E7, in addition to the front direction of the driver. That is, it is possible to determine not only whether or not the driver is gazing at any direction other than the front direction, that is, whether or not the driver is intentionally visually conscious, but also the degree of consciousness.

Therefore, when the driver is gazing at an area other than the front direction, it is possible to suppress the issuance of the alert in the gaze direction, assuming that the driver is fully aware of the area in the gaze direction. As a result, it is possible to suppress the annoyance to the driver due to unnecessary alert or warning. In addition, if the driver's consciousness in the front direction is insufficient, the alert can be made as the driver is looking aside.

(3b) According to the present embodiment, since the state information of the viewable areas E1 to E7 and the closed-eye E8 are represented by binary values, the memory capacity required for accumulating these state information can be reduced.

### 4. Modifications

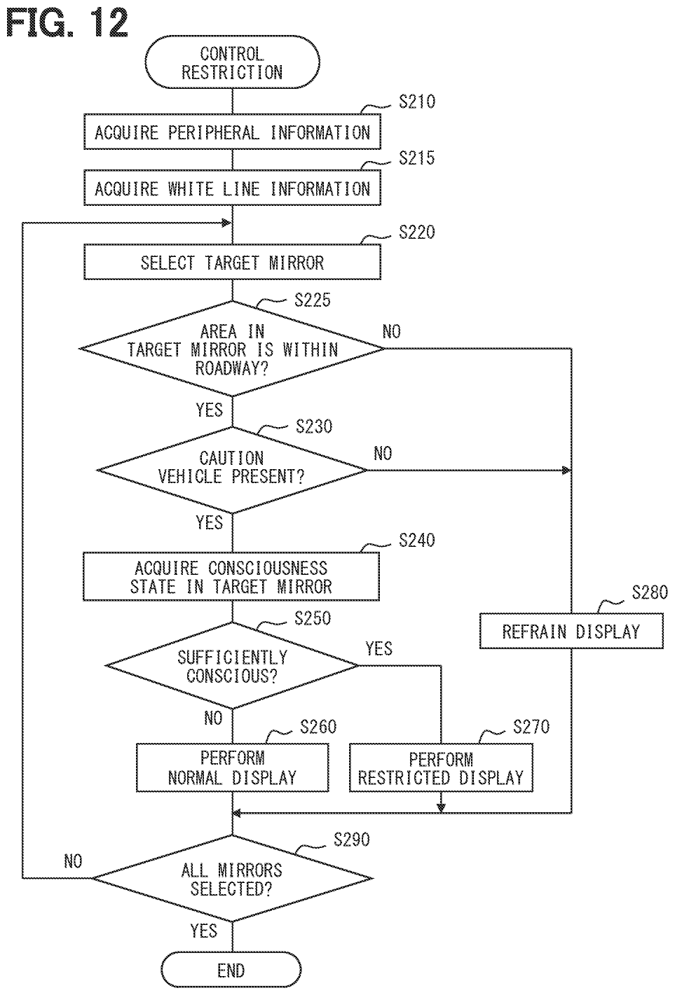

In the present embodiment, the determination result of the consciousness state is linked to the control of the BSM by the control restriction processing. As a modification, white line information may also be linked in addition to the determination result of the consciousness state. In this case, a control restriction processing shown in a flowchart of FIG. 12 may be performed, in place of the control restriction processing shown in FIG. 11. The control restriction processing of the modification is the same as the contents of the flowchart of FIG. 11 except that the processing of S215 and S225 are added.

In S215, the processing unit 20 acquires white line information from the in-vehicle device group 40.

In S225, the processing unit 20 identifies a traveling lane in which the subject vehicle is traveling from the white line information and the position of the subject vehicle, and determines whether or not the region reflected in the target mirror is within a range of a roadway. In other words, when there are multiple lanes and when the subject vehicle is in the leftmost lane, the region reflected in the left mirror is outside of the roadway. Likewise, when the subject vehicle is in the rightmost lane of the multiple lanes, the region reflected in the right mirror is outside of the roadway.

When it is determined that the region reflected in the target mirror is within the range of the roadway, the processing unit 20 shifts the processing to S230 as the region is to be the target of the BSM. When it is determined that the region reflected in the target mirror is outside the roadway, the processing unit 20 shifts the processing to S280 as the region is not the target of the BSM.

According to this modification, it is possible to suppress the driver's annoyance due to the alert by the BSM.

In the control restriction processing of the modification, the processing of S215 corresponds to a lane acquisition unit.

### 5. Other Embodiments

Although the embodiment(s) of the present disclosure have been described hereinabove, the present disclosure is not limited to the embodiment(s) described hereinabove, and various modifications can be made to implement the present disclosure.

(5a) In the embodiment described above, the consciousness areas A1 to A4 are set on the periphery of the vehicle, but may be set to areas other than the periphery of the vehicle. For example, the consciousness areas may include the arm's reach area, and it may be possible to determine a distraction state in which the driver is inattentive to the periphery of the vehicle.

(5b) In the embodiment described above, an example in which the determination result of the state of consciousness is linked with the BSM has been described. However, the present disclosure is not limited to the application to the BSM, but may be linked with various applications related to safety. For example, the determination result of the river's consciousness state may be used for an alert for a vehicle stopped ahead of the subject vehicle, an alert for an interrupting vehicle, an alert when the subject vehicle changes lanes or turns left or right, and the like.

(5c) In the embodiment described above, the aggregation value is calculated by adding the viewable areas to which the driver is viewing. However, it is not always necessary to calculate the aggregation value by addition. For example, the aggregation value may be initialized to the upper limit value, and the aggregation value of the viewable area at which the driver is gazing may be subtracted. Further, the aggregation value may be produced by adding or subtracting the aggregation value of the viewable area at which the driver is not gazing. For example, the aggregation value of the viewable area at which the driver is gazing may be increased or decreased at a preset rate. As another example, the aggregation value of the viewable area at which the driver is not gazing may be increased or decreased at a preset rate.

(5d) The processing unit 20 and the method executed by the processing unit 20 described in the present disclosure may be implemented by a special purpose computer which is configured with a memory and a processor programmed to execute one or more particular functions embodied in computer programs of the memory. Alternatively, the processing unit 20 and the method executed by the processing unit 20 of the present disclosure may be achieved by a dedicated computer which is configured with a processor with one or more dedicated hardware logic circuits. Alternatively, the processing unit 20 and the method executed by the processing unit 20 of the present disclosure may be realized by one or more dedicated computer, which is configured as a combination of a processor and a memory, which are programmed to perform one or more functions, and a processor which is configured with one or more hardware logic circuits. Further, the computer program may be stored in a computer-readable non-transitory tangible storage medium as instructions to be executed by a computer. The technique for realizing the functions of each unit included in the processing unit 20 does not necessarily need to include software, and all the functions may be realized using one or a plurality of hardware circuits.

(5e) The multiple functions of one component in the embodiments described above may be implemented by multiple components, or a function of one component may be implemented by multiple components. Further, multiple functions of multiple elements may be implemented by one element, or one function implemented by multiple elements may be implemented by one element. A part of the configuration of the embodiments described above may be omitted. At least a part of the configuration of the embodiments described above may be added to or replaced with the configuration of another one of the embodiments described above.

(5f) In addition to the consciousness determination device 1 described above, the present disclosure may be implemented in various other ways, such as by a system having the consciousness determination device 1 as a component, a program for operating a computer as the processing unit 20 constituting the consciousness determination device 1, a non-transitory tangible storage medium, such as a semiconductor memory, storing the program therein, a consciousness determination method, and the like.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A consciousness determination device comprising:
an information generation unit configured to generate a time series of a plurality of detection elements that includes a line-of-sight state indicating to which of a plurality of preset viewable areas a line of sight of a driver driving a vehicle is directed and an open/closed state of driver's eyes;
an extraction unit configured to extract detection data from the time series of the detection elements using a time window having a preset time width;
an aggregation unit configured to aggregate the line-of-sight state of the driver with respect to each of the plurality of viewable areas using the detection data; and
a determination unit configured to determine, based on an aggregation result of the aggregation unit, at least one of (i) a state of consciousness of the driver with respect to each of the plurality of viewable areas and (ii) a state of consciousness of the driver with respect to an event associated with each of the plurality of viewable areas.

2. The consciousness determination device according to claim 1, further comprising:
a map display unit configured to display a peripheral area of the vehicle of which the driver is aware according to a determination result of the determination unit.

3. The consciousness determination device according to claim 2, wherein
the determination unit is configured to determine the state of consciousness of the driver in a plurality of levels, and
the map display unit is configured to change a display mode according to the level of the state of consciousness.

4. The consciousness determination device according to claim 1, wherein
the state of consciousness of the driver includes an unconscious state in which the driver cannot recognize a change of the event, a conscious state in which the driver can recognize the change of the event, and a looking aside state in which the driver is unconscious in a front area.

5. The consciousness determination device according to claim 1, further comprising:
an aggregation value display unit configured to display the aggregation result of the aggregation unit.

6. The consciousness determination device according to claim 5, wherein
the aggregation value display unit is configured to display the aggregation result of the aggregation unit in at least one of a histogram format and a graph format showing a change in the aggregation result with an elapse of time.

7. The consciousness determination device according to claim 1, wherein
the detection elements additionally include a face orientation of the driver.

8. The consciousness determination device according to claim 1, wherein
the aggregation unit is configured to increase or decrease the aggregation value of the viewable area to which the line of sight of the driver is directed at a preset rate.

9. The consciousness determination device according to claim 1, wherein
the aggregation unit is configured to increase or decrease the aggregation value of the viewable area to which the line of sight of the driver is not directed at a preset rate.

10. The consciousness determination device according to claim 1, further comprising:
a control restriction unit configured to restrict an alert in an alert control for a target viewable area, the target viewable area being one of the plurality of viewable areas and determined as being conscious by the driver, the alert control producing the alert to the driver in the target viewable area.

11. The consciousness determination device according to claim 10, wherein
the target viewable area is an area including a side mirror of the vehicle, and
the alert control includes a control by a blind spot monitor.

12. The consciousness determination device according to claim 10, further comprising:
a lane acquisition unit configured to acquire information indicating a range of a roadway in a road on which the vehicle is traveling, wherein
the control restriction unit is configured to restrict the alert by the alert control when a range visually recognized by the driver through the target viewable area is outside the range of the roadway.

13. A conscious determination method comprising:
generating a time series of a plurality of detection elements that includes a line-of-sight state indicating to which of a plurality of preset viewable areas a line of sight of a driver driving a vehicle is directed and an open/closed state of driver's eyes;
extracting detection data from the time series of the detection elements using a time window having a preset time width;
aggregating the line-of-sight state with respect to each of the plurality of viewable areas using the detection data; and
determining, based on aggregation results of the respective viewable areas, at least one of (i) a state of consciousness of the driver with respect to each of the plurality of viewable areas and (ii) a state of consciousness of the driver for an event associated with each of the plurality of viewable areas.

14. A conscious determination device for a vehicle, comprising:
a processor and a memory configured to:
generate a time series of a plurality of detection elements that includes a line-of-sight state indicating to which of a plurality of preset viewable areas a line of sight of a driver of the vehicle is directed and an open/closed state of driver's eyes;
extract detection data from the time series of the detection elements using a time window having a preset time width;
aggregate the line-of-sight state with respect to each of the plurality of viewable areas using the detection data; and
determine, based on aggregation results of the respective viewable areas, at least one of (i) a state of consciousness of the driver with respect to each of the plurality of viewable areas and (ii) a state of consciousness of the driver for an event associated with each of the plurality of viewable areas.
